(19) United States
(12) Patent Application Publication
(10) Pub. No.: US 2007/0181023 A1
(43) Pub. Date: Aug. 9, 2007

(54) Ink fountain for a printing machine

(76) Inventors: Daniel Baertschi, Les Monts-De-Pully (CH); Gabriel Hermann, Etagnieres (CH); Giovanni Bentivoglio, Prilly (CH); Gaetano Bollettin, Landriano (IT)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/594,610

(22) PCT Filed: Apr. 8, 2005
(86) PCT No.: PCT/IB05/00953

§ 371 Date: Sep. 28, 2006

(30) Foreign Application Priority Data
Apr. 22, 2004 (EP) 04009528.3

(51) Int. Cl. B41F 31/02

(52) U.S. Cl. 101/365

(57) ABSTRACT

The invention concerns an ink fountain with a blade support wherein said blade support comprises several adjacent sections moveable by setting means to vary the distance between said sections and the circumference of an ink fountain cylinder. The ink fountain further comprises a blade interposed between said sections and the circumference of the ink fountain cylinder and having a ridge for maintaining a specific thickness of ink on the ink fountain cylinder, the blade resting directly on said sections and being fixed relative to said blade support.

The present invention relates to an ink fountain for a printing machine having a base with a blade holder, in which said blade holder comprises a number of adjacent sectors which can be moved by adjusting means in order to vary the distance between said sectors and the circumference of an ink fountain roller.

These blades and ink fountains are used mainly in intaglio printing machines, in which machines the amount of ink which is applied to the ink fountain roller is large in order to adequately ink the incisions in the printing plates.

Ink fountain blades and ink fountains of this type are known in the prior art. For example, patent DD 110 632 discloses an ink fountain whose base comprises a blade which is close to the circumference of the ink fountain roller. In order to vary the distance between the edge of the blade and the roller, that is to say the thickness of ink applied to the cylinder, the blade is deformed elastically by screws which press against the blade, on the other side of this blade with respect to the ink fountain roller.

The major drawback of this system lies in the fact that the deformation of the blade does not allow a constant thickness of ink to be applied. This is because the profile of the deformed blade has, roughly speaking, a rounded edge since the screws press at a point location on the blade, with the result that the metering of the ink is in fact inaccurate.

Another system is described in patent application EP 0 600 435. In this system, the ink fountain blade is formed by a number of adjacent bladelets which can be deformed elastically in order to modify the thickness of the ink applied to the ink fountain roller. To obtain this deformation, use is made in this case too of a lever on the other side of the bladelets with respect to the ink fountain roller in order to move them closer to this roller and thus alter the distance between the edge of each bladelet and the circumference of the ink fountain roller and hence the thickness of the ink applied.

This system has several drawbacks, particularly the fact that the deformation of the bladelets occurs in the direction of the ink fountain roller. Thus, in the event of a handling error, there is a risk that the blade will come into contact with the roller and damage it. The deformation of the blades also leads to material fatigue, which may create problems of premature wear.

Another system is known from patent application EP 1 031 419. The ink fountain base blade described has the special feature of being formed by sectors which can be moved parallel to one another and independently in the plane of the blade.

Other systems are known in the prior art, in particular from the publications DE 82 08 651.6, DE 35 03 736, DE 29 51 653, EP 0 046 206, FR 419 472, EP 1 092 535, U.S. Pat. Nos. 4,773,327 and 3,456,585.

Finally, U.S. Pat. No. 4,236,955 discloses an inking system in which a blade is interposed between the sectors and the inking cylinder in order to perform the function of adjusting the ink thickness. However, the sectors bear only along a contact edge or line against the blade in question. On either side of this contact edge, the blade does not rest on any support. Under the effect of the ink maintained between the blade and the ink fountain roller, stresses will necessarily be applied to the unsupported parts of the blade, on either side of the support edge formed by the sectors, and this will result in deformations of the blade and in the ink thickness adjusting function being diminished if the blade does not have sufficient thickness and rigidity. Moreover, the blade is not strictly speaking held fixedly with respect to the blade holder and its sectors. This is because a specific mechanism is provided for positioning the blade, independently of the position of the sectors. This complicates the adjustment of the ink thickness because the positioning of the blade and the positioning of the sectors each affect the ink thickness adjustment.

The object of the invention is to improve the known systems.

More specifically, the object of the invention is to provide a blade and an ink fountain which allow better metering of the ink.

Another object of the invention is to provide a blade and an ink fountain which produce quality inking.

Another object of the invention is to provide an ink fountain whose elements can easily be removed and exchanged in the event of wear.

To this end, the invention is defined by the features of the claims.

The present invention will be better understood by the description of two embodiments of the invention and of drawings illustrating these embodiments by way of nonrestrictive examples.

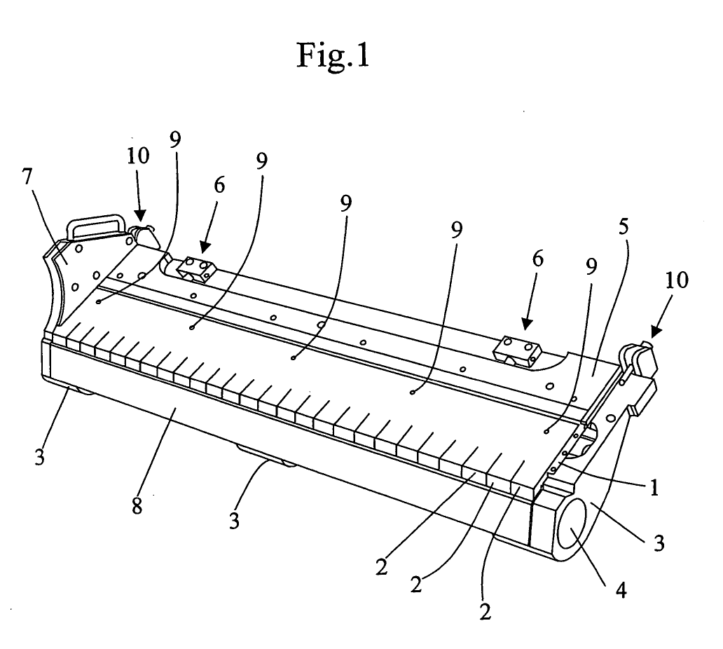

FIG. 1 shows a perspective plan view of an ink fountain according to a first embodiment of the invention.

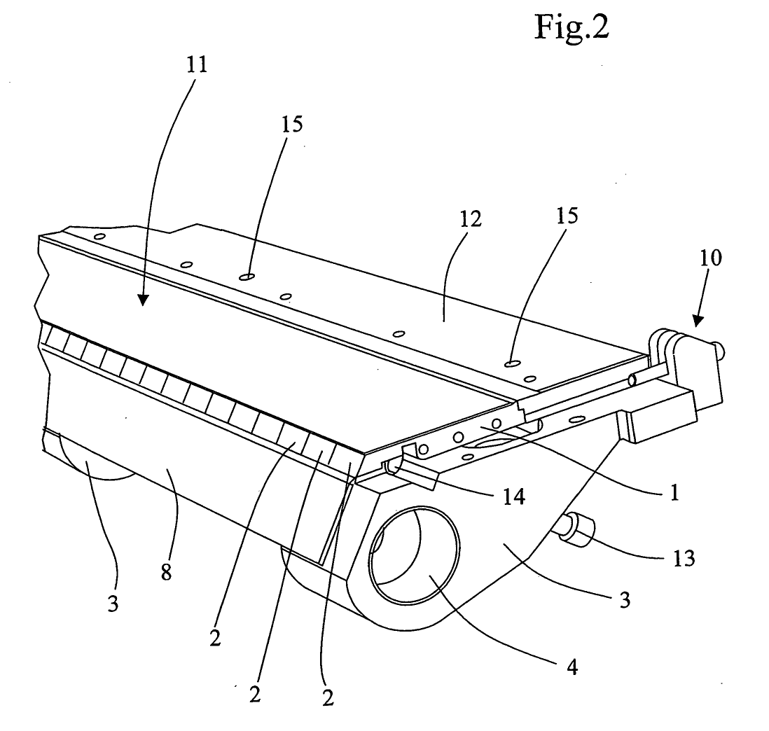

FIG. 2 shows a perspective side view of an ink fountain according to a first embodiment of the invention.

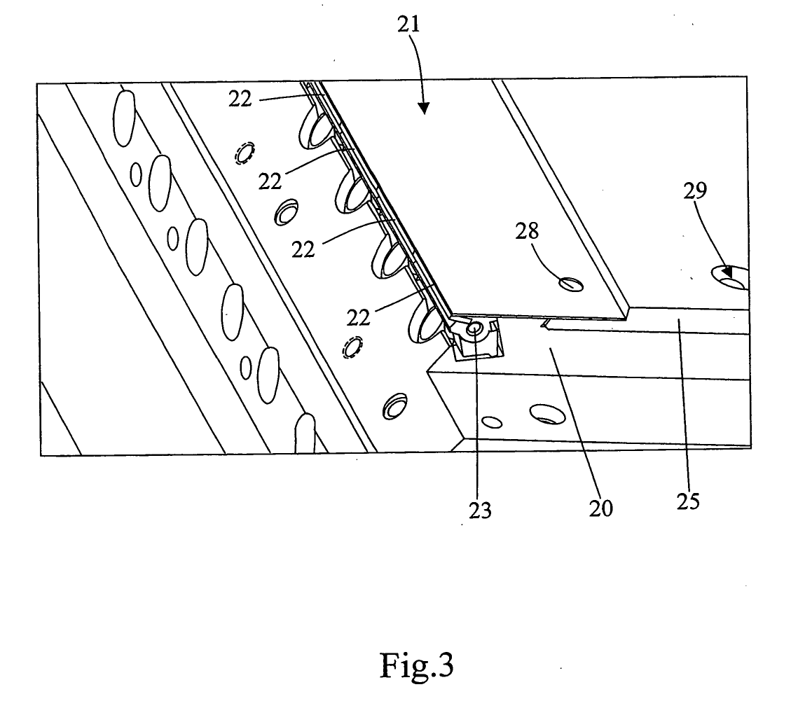

FIG. 3 shows a perspective lateral view of a second embodiment of the invention in the partially assembled state.

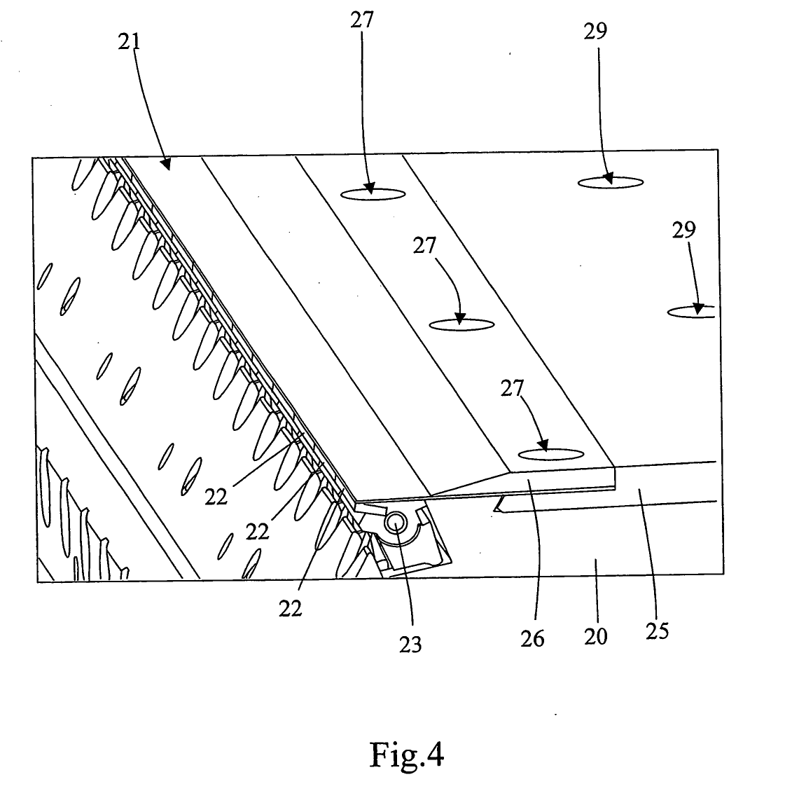

FIG. 4 shows a lateral perspective view of a second embodiment of the invention in the assembled state.

In the first embodiment represented in FIG. 1, the ink fountain comprises a blade holder 1 having contiguous sectors 2 which, by virtue of their position relative to the inking roller (not shown), make it possible to define the thickness of ink deposited on said roller. The blade holder 1 is mounted on ink fountain supports 3, themselves mounted on a shaft (not shown) passing through the opening so as to allow the blade holder 1 of the ink fountain to be tilted. In this embodiment, the sectors 2 are not continued over the whole width of the blade holder 1 and are moved by deformation of the blade holder 1 in a manner which will be described at a later point in the present application. The ink fountain also comprises a reference stop 5 which can be adjusted by means of screws 6, it being possible for said stop to be formed in a single piece with the blade holder 1, lateral closure walls 7, and a guard strip 8. The closure walls are known in the prior art, for example from publication EP 1 022 138, the content of which is incorporated by reference in connection with these ink fountain lateral walls. The blade holder 1 also comprises holes 9 whose utility will be explained at a later point in the present application.

The ink fountain additionally comprises clamping systems 10 for retaining the lateral walls 7.

In FIG. 2, those elements which are identical to the ones in FIG. 1 are identified using the same reference numbers. To the blade holder 1 has been directly fastened an ink fountain blade 11, and the reference stop 5 is closed by a cover 12, for example screwed on by means of the screws 15.

The ink fountain blade 11 makes it possible to adjust the thickness of ink deposited while maintaining a continuous edge, unlike the individual sectors 2. Specifically, it has been observed that, in spite of the very precise tolerances between the sectors, ink passed between said sectors, leading to running and inaccurate inking. The use of a blade such as the blade 11 according to the invention makes it possible to maintain a continuous edge and thus improve the inking. The thickness of the ink is adjusted manually by means of screws 13 (there is one screw for each segment) whose distal end bears directly below each segment 2. Hence, screwing in the screws 13 makes it possible, by deformation of the respective segment 2 with respect to the blade holder 1, to modify the distance of the upper edge of said segment 2 with respect to the inking roller, and thus the edge of the ceramic blade 11.

Preferably, to improve the system, a deformable plastic is deposited between the sectors to improve the sealing between them.

The blade 11 comprises tie rods with tapped bores which enter the holes 9 in the blade holder 1 (see FIG. 1), thereby enabling it to be fixedly attached to the blade holder 1 by screwing, the screws being inserted from below the blade holder 1. According to a variant, the blade 11 can be screwed onto the blade holder from above.

In the second embodiment of FIGS. 3 and 4, the ink fountain is of a type differing from that of the first embodiment. In the first embodiment, the thickness of the ink was adjusted manually by acting on screws 13 (see FIG. 2) and by forcing the movement of the sectors 2. In the second embodiment, the ink fountain is of the type known by the name of“Colortronic MC” (sold by Koenig & Bauer AG), in which the sectors which define the thickness of the ink are actuated automatically to rotate on a shaft. Thus, there is no deformation of sectors with respect to the blade holder in this embodiment.

FIG. 3 shows a blade holder 20 with a reference stop 25. On that side of the blade holder 20 which is close to the inking roller (not shown) are the sectors 22 which enable the inking thickness to be adjusted. As indicated above, this system operates on the principle of the machine known by the name of“Colortronic MC”, in which the sectors 22 are mounted on a shaft 23 and are rotated automatically to adjust the thickness of the ink on the inking roller.

Above the sectors 22 has been placed a blade 21 which directly covers the sectors 22 according to the principle of the invention. Thus, it is the edge of this blade 21 which continuously adjusts the thickness of the ink along the ink fountain, and no longer the independent sectors 22. Of course, although not represented in FIGS. 3 and 4, this embodiment can also include a guard strip 8 as in the first embodiment.

FIG. 4 shows the ink fountain with the blade holder 20 mounted, in the use configuration. In this configuration, the blade 21 is fastened to the blade holder 25 by a fastening piece 26 which extends over the whole width of the ink fountain, this piece 26 being attached to the blade holder 25 by means of screws 27 which pass through holes 28 (FIG. 3) in the blade 21 in order to be screwed into tapped bores in the blade holder 25.

The reference stop 25 is attached to the blade holder 20 by means of screws or by some other suitable means, for example.

The blade 11 or 21 according to the invention thus forms a wearing part which can be easily exchanged and which has a low cost. Preferably, the blade is made of steel having a thickness of about 1 to 3 mm and comprises a ceramic deposit a few microns thick which makes it possible to substantially increase the service life of the blade. It is the case that the inks used have abrasive properties which wear the edge of the blade, and consequently the ceramic deposit makes it possible to reinforce this edge.

Of course, the embodiments described are done so by way of example, and variations are possible within the scope of the protection claimed. Likewise, means equivalent to those described are possible.

1. An ink fountain for a printing machine, having a base with a blade holder, in which said blade holder comprises a number of adjacent sectors which can be moved by adjusting means in order to vary the distance between said sectors and the circumference of an ink fountain roller, said ink fountain additionally comprising a blade which is interposed between said sectors and the circumference of the ink fountain roller and which has a continuous edge intended to maintain a defined ink thickness on the ink fountain roller, the ink thickness being adjusted by said continuous edge of the blade and defined by the position of said sectors, which is transmitted to said blade, wherein said blade rests directly on said sectors and is held fixedly with respect to said blade holder.

2. The ink fountain as claimed in claim 1, in which the blade includes a ceramic deposit to reinforce said edge of the blade.

3. The ink fountain as claimed in claim 2, wherein the blade is a metal blade.

4. The ink fountain as claimed in claim 1, in which the blade is screwed into the blade holder.

5. The ink fountain as claimed in claim 1, in which the blade is held on the blade holder by a fastening piece.

6. The ink fountain as claimed in claim 1, in which the sectors are moved by deformation.

7. The ink fountain as claimed in claim 1, in which the sectors are moved by rotation.

8. The ink fountain as claimed in claim 1, in which a deformable plastic is deposited between the sectors to improve the sealing between them.
